(19) United States
(12) Patent Application Publication
(10) Pub. No.: US 2014/0240652 A1
(43) Pub. Date: Aug. 28, 2014

(54) SEE-THROUGH DISPLAY DEVICE, AND ELECTRICAL DEVICE AND FURNITURE PIECE EACH OF WHICH IS PROVIDED WITH SEE-THROUGH DISPLAY DEVICE

(71) Applicants: Eiji Satoh, Osaka-shi (JP); Akio Miyata, Osaka-shi (JP); Kazuhiro Deguchi, Osaka-shi (JP)

(72) Inventors: Eiji Satoh, Osaka-shi (JP); Akio Miyata, Osaka-shi (JP); Kazuhiro Deguchi, Osaka-shi (JP)

(73) Assignee: SHARP KABUSHIKI KAISHA, Osaka-shi, Osaka (JP)

(21) Appl. No.: 14/008,655

(22) PCT Filed: Mar. 27, 2012
(86) PCT No.: PCT/JP2012/057951

§ 371 Date: Sep. 30, 2013

(30) Foreign Application Priority Data
Mar. 29, 2011 (JP) 2011-072870

(51) Int. Cl. G02F 1/17; G02B 26/00; G02F 1/167; G02F 1/153; G02F 1/155

(52) U.S. Cl. CPC G02F 1/17; G02F 1/153; G02F 1/155; G02F 1/167; G02B 26/005; G02F 2001/1502
USPC 349/165; 359/238; 359/275; 359/296; 359/290

(57) ABSTRACT

A see-through display device (100A) according to the present invention includes a first substrate (11) and a second substrate (12) disposed opposing to each other and a light modulation layer (17) disposed between the first substrate (11) and the second substrate (12). The light modulation layer (17) contains at least two types of materials which come into a bleached state or a colored state depending on an applied voltage and which have visible light absorption spectra different from each other.

### TECHNICAL FIELD

The present invention relates to a see-through display device and see-through display device-equipped electric apparatus and furniture.

### BACKGROUND ART

In recent years, a see-through display device has been proposed (NPL 1). The see-through display device can be utilized as an alternative to, for example, a windowpane because a background can be seen through the display device.

Meanwhile, PTL 1 discloses an electrochromic apparatus which can be produced inexpensively by using a solid electrolyte without complicating the structure of the apparatus. In the electrochromic apparatus described in PTL 1, when a voltage is not applied to a layer including an electrochromic material (referred to as an electrochromic layer), the electrochromic layer is in a bleached state, and when a voltage is applied to the electrochromic layer, the electrochromic layer becomes, for example, blue. It is mentioned that the electrochromic apparatus can also be used for a window.

### CITATION LIST

### Patent Literature

PTL 1: Japanese Unexamined Patent Application Publication No. 4-251826 Non Patent Literature
NPL 1: E. Satoh and thirteen others “60-inch Highly Transparent See-through Active Matrix Display without Polarizers” SID 10 DIGEST p 1192-1195

### SUMMARY OF INVENTION

### Technical Problem

However, in the electrochromic apparatus disclosed in PTL 1, multicolor and multi-gradation display are not possible. Meanwhile, if a see-through display device is produced by using a transparent liquid crystal display device including a polarizer or/and a color filter layer, a high transmittance is not obtained and, therefore, there is a problem in that a background is not seen through the see-through display device easily. In addition, the see-through liquid crystal display device described in NPL 1 (FIG. 6) is monochrome and it is necessary to dispose a projector to colorize.

The present invention has been made in consideration of the above-described problems, and it is an object thereof to provide a see-through display device having a high transmittance and being capable of multicolor and multi-gradation display.

### Solution to Problem

A see-through display device according to the present invention includes a first substrate and a second substrate disposed opposing to each other and a light modulation layer disposed between the above-described first substrate and the above-described second substrate, wherein the above-described light modulation layer contains at least two types of materials which come into a bleached state or a colored state depending on an applied voltage and which have visible light absorption spectra different from each other.

In an embodiment, the above-described light modulation layer is an electrochromic layer.

In an embodiment, the above-described see-through display device further includes a solid electrolyte layer or an electrically conductive polymer layer, wherein a voltage is applied to the above-described electrochromic layer through the above-described solid electrolyte layer or the above-described electrically conductive polymer layer.

In an embodiment, the above-described see-through display device further includes a protective layer covering the above-described solid electrolyte layer or the above-described electrically conductive polymer layer and the above-described electrochromic layer.

In an embodiment, the above-described see-through display device further includes a transparent electrode disposed on the electrochromic layer side of the above-described protective layer.

In an embodiment, the above-described electrochromic layer includes an oxidation type electrochromic layer and a reduction type electrochromic layer, the above-described oxidation type electrochromic layer has a first oxidation type electrochromic region containing a single oxidation type color production material over two pixels adjoining in a line direction, and the above-described reduction type electrochromic layer has a first reduction type electrochromic region containing a single reduction type color production material over two pixels adjoining in a line direction.

In an embodiment, the oxidation type electrochromic layer has a second oxidation type electrochromic region including two portions containing oxidation type color production materials, which correspond to two pixels adjoining in a line direction and which have light absorption wavelengths different from each other in a colored state, the above-described reduction type electrochromic layer has a second reduction type electrochromic region including two portions containing reduction type color production materials, which correspond to two pixels adjoining in a line direction and which have light absorption wavelengths different from each other in a colored state, and the above-described electrochromic layer is disposed in such a way that the above-described first oxidation type electrochromic region is opposed to the above-described second reduction type electrochromic region and the above-described first reduction type electrochromic region is opposed to the above-described second oxidation type electrochromic region.

In an embodiment, the above-described light modulation layer is an electrophoresis layer.

In an embodiment, the above-described see-through display device includes two electrodes to apply a voltage to the above-described electrophoresis layer, wherein the sizes of the above-described two electrodes are different from each other.

In an embodiment, the above-described light modulation layer is a liquid crystal layer containing a dichromatic coloring agent.

In an embodiment, the above-described light modulation layer is an electrowetting layer.

In an embodiment, the above-described see-through display device includes a plurality of light modulation layers including the above-described light modulation layer, wherein the above-described plurality of light modulation layers overlap each other when viewed from the direction normal to the above-described first substrate.

A see-through display device according to the present invention includes a first substrate and a second substrate disposed opposing to each other and a light modulation layer disposed between the above-described first substrate and the above-described second substrate, wherein the light from the above-described light modulation layer has at least three absorption spectra different from each other depending on an applied voltage, and one of the above-described at least three absorption spectra has a light absorptivity of 40% or less at the wavelength at which the light absorptivity is the lowest in a visible light region.

In an embodiment, the above-described light modulation layer is an electrochromic layer.

In an embodiment, an electrochromic compound contained in the above-described electrochromic layer is one type.

In an embodiment, the above-described see-through display device further includes a solid electrolyte layer or an electrically conductive polymer layer, wherein a voltage is applied to the above-described electrochromic layer through the above-described solid electrolyte layer or the above-described electrically conductive polymer layer.

In an embodiment, the above-described see-through display device further includes a protective layer covering the above-described solid electrolyte layer or the above-described electrically conductive polymer layer and the above-described electrochromic layer.

In an embodiment, the above-described see-through display device further includes a transparent electrode disposed on the above-described electrochromic layer side of the above-described protective layer.

In an embodiment, the above-described light modulation layer is an electrophoresis layer.

In an embodiment, the above-described electrophoresis layer contains first charged color fine particles having a first amount of charge and second charged color fine particles having a second amount of charge different from the above-described first amount of charge, and the color of the above-described first charged color fine particles is different from the color of the above-described second charged color fine particles.

In an embodiment, the above-described see-through display device includes a first electrode and a second electrode to apply a voltage to the above-described electrophoresis layer, wherein the size of the above-described first electrode is smaller than the size of the above-described second electrode.

In an embodiment, the above-described see-through display device further includes a light-transmissive light-irradiation apparatus disposed on the side opposite to the above-described light modulation layer side of the above-described first substrate.

In an embodiment, the above-described see-through display device includes a reflection type prevention film on at least one of the observer side of the above-described see-through display device and the side opposite to the observer side of the above-described see-through display device.

An electric apparatus according to the present invention includes the above-described see-through display device.

Furniture according to the present invention includes the above-described see-through display device.

### Advantageous Effects of Invention

According to the present invention, a see-through display device having a high transmittance and being capable of multicolor and multi-gradation display is provided.

### BRIEF DESCRIPTION OF DRAWINGS

FIG. 1 (a) is a schematic sectional view of a display device 100A in an embodiment according to the present invention, and (b) is a schematic sectional view of a modified example of the display device 100A.

FIG. 2 (a) is a schematic sectional view of a display device 100B in another embodiment according to the present invention, (b) is a magnified diagram of a portion surrounded by a broken line A in (a), (c) is a schematic sectional view of a display device 100C in another embodiment according to the present invention, and (d) is a magnified diagram of a portion surrounded by a broken line B in (c).

FIG. 3 (a) is a schematic sectional view of a display device 100D in another embodiment according to the present invention, and (b) is a schematic sectional view of a display device 100E in another embodiment according to the present invention.

FIG. 4 is a schematic sectional view of a display device 100F in another embodiment according to the present invention.

FIG. 5 is a schematic sectional view of a display device 100G in another embodiment according to the present invention.

FIGS. 6 (a) and (b) are schematic sectional views of a display device 100H in another embodiment according to the present invention.

FIG. 7 (a) is a schematic sectional view of a display device 100I in another embodiment according to the present invention, and (b) is a schematic sectional view of a modified example of the display device 100I.

FIG. 8 is a schematic sectional view of a display device 100J in another embodiment according to the present invention.

FIG. 9 is a schematic sectional view of a display device 100K in another embodiment according to the present invention.

FIGS. 10 (a) and (b) are diagrams illustrating aspects in which the display device 100A is used.

### DESCRIPTION OF EMBODIMENTS

See-through display devices in embodiments according to the present invention will be described below with reference to the drawings. In this regard, the present invention is not limited to the embodiments shown as examples.

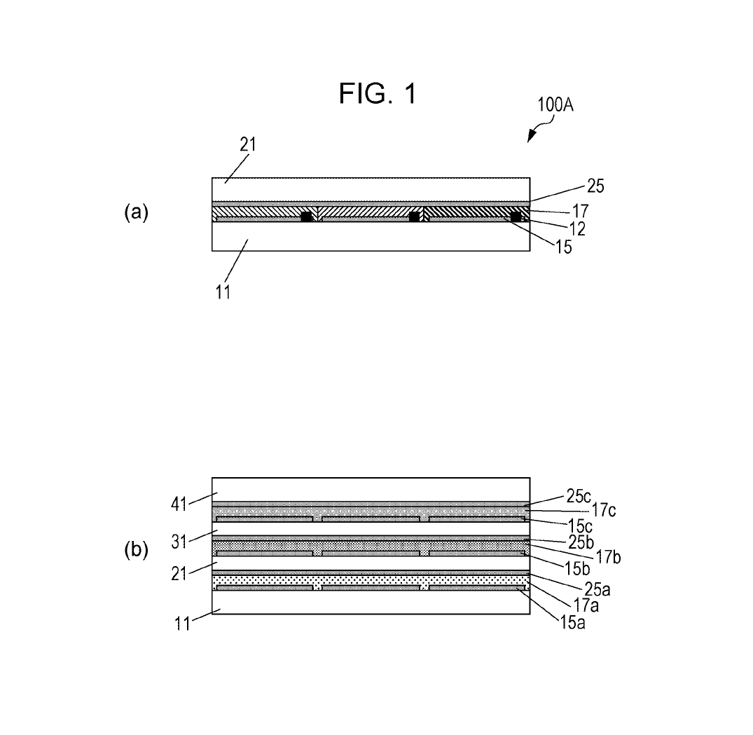

A display device 100A in an embodiment according to the present invention will be described with reference to FIG. 1. The display device 100A is a see-through display device. FIG. 1 (a) is a schematic sectional view of the display device 100A.

The display device 100A shown in FIG. 1 (a) includes a first substrate (for example, glass substrate) 11, a second substrate (for example, glass substrate) 21 opposing to the first substrate 11, and a light modulation layer 17 disposed between the first substrate 11 and the second substrate 21. A transparent electrode 15 made from, for example, ITO (Indium Tin Oxide) is disposed on the light modulation layer 17 side of the first substrate 11. A transparent electrode 25 made from, for example, ITO is disposed on the light modulation layer 17 side of the second substrate 21. The light modulation layer 17 is disposed between the transparent electrode 15 and the transparent electrode 25. The light modulation layer 17 comes into a bleached state or a colored state depending on an applied voltage. Here, the bleached state refers to a state in which the light transmittance of the visible light in a whole wavelength region (400 nm or more and 800 nm or less) is 60% or more (hereafter the same goes for see-through display devices 100B to 100I described later).

The light modulation layer 17 contains at least two types of materials having visible light absorption spectra different from each other. The light modulation layer 17 is, for example, an electrochromic layer containing an electrochromic material. The electrochromic layer includes an electrolyte solution (electrolytic solution), although not shown in the drawing. Alternatively, the light modulation layer 17 may be an electrophoresis layer, a guest host liquid crystal layer, or a cholesteric liquid crystal layer containing a cholesteric liquid crystal material. The light modulation layer 17 is made from, for example, materials having absorption spectra different from each other on a pixel basis, and each material produces a color, e.g., R (red), G (green), or B (blue) in a colored state (when a voltage is applied). Meanwhile, in the case where the light modulation layer 17 has memory effects, the power consumption can be reduced.

The transparent electrode 15 is disposed on a pixel basis, for example, and each transparent electrode 15 is electrically connected to an active element (for example, thin film transistor: TFT) 12 disposed on a pixel basis. The display device 100A is driven by an active drive system, for example. The display device 100A is not limited to this and may be driven by a passive drive system. In addition, a display region may be divided into areas exhibiting mutually different colors, and the areas may be driven independently by a segment drive system. Furthermore, each of the transparent electrode 15 and the transparent electrode 25 may be disposed evenly all over the display device 100A, and display may be performed evenly all over the surface. The same goes for the display devices 100B to 100K described below.

As shown in FIG. 1 (b), the display device 100A may be modified in such a way as to have a structure in which light modulation layers 17a to 17c to produce mutually different colors are stacked. In this case, the light modulation layers 17a, 17b, and 17c are disposed between their corresponding transparent electrodes 15a and 25a, 15b and 25b, and 15c and 25c, respectively. The individual transparent electrodes 15a to 15c and 25a to 25c are disposed on their respective substrates (for example, glass substrates) 11, 21, 31, and 41. Furthermore, the individual transparent electrodes 15a to 15c and 25a to 25c may be disposed evenly all over the surface of the display device, and display may be performed evenly all over the surface.

The substrates 11, 21, 31, and 41 may be plastic substrates made from, for example, acrylic resin, PEN (Polyethylene naphthalate), PET (Polyethylene terephthalate), or PES (Poly Ether Sulphone) other than the glass substrate.

In general, the electrochromic layer comes into a bleached state or a colored state by being oxidized or reduced by a voltage applied to the electrochromic material present in the electrolyte solution (electrolytic solution). As for the electrolyte solution, acetonitrile, NMP (1-methyl-2-pyrrolidone), DMSO (dimethyl sulfoxide), or the like is used as a solvent, and TBAP (tetrabutylammonium perchlorate), TEAP (tetraethylammonium perchlorate), or the like is used as an electrolyte. For example, a styryl based coloring agent is used as a material of a type in which a color is produced by oxidation of the electrochromic material, and for example, a phthalic acid derivative or viologen is used as a material of a type in which a color is produced by reduction of the electrochromic material. In addition, preferably, ferrocene or the like is included as a counter electrode agent. For example, in the case where the electrochromic material is a reduction type color production material, the counter electrode agent has an effect of stabilizing a reaction system by inducing an oxidation reaction in the electrode opposing to the electrode contributing to color production of the material.

Usually, in the state in which the electrochromic material is dispersed in a solution, the electrochromic material hardly has memory effects. The reason therefor is that when power supply is stopped, colored molecules are diffused and are bleached by, for example, exchange of electrons with the counter electrode agent. As one method for providing the memory effects, a method in which carboxylic acid, phosphoric acid, or the like is introduced as an anchor into the electrochromic material and fine particles of titanium oxide, zinc oxide, or the like disposed on the substrate are allowed to adsorb the electrochromic material is mentioned. Examples of other methods include a method in which the viscosity of the electrolytic solution is increased by adding a polymer or the like and a method in which gelation or solidification is induced. These methods have an effect of preventing or decreasing diffusion of the colored electrochromic material. Examples of methods for forming regions exhibiting mutually different colors include a method in which fine particles of titanium oxide or the like are applied to the substrate and the electrochromic material dissolved in a solvent is applied to the fine particles on a color basis by an ink jet apparatus.

Meanwhile, in the case where a solid electrolyte, an electrically conductive polymer, or a gel electrolyte is used in place of the above-described electrolyte solution, the above-described memory effects can be provided and, in addition, the pressure resistance of the display device 100A can be improved. Furthermore, in the case where the display device 100A is damaged, leakage of an electrolytic solution does not occur. In particular, in the case where the substrate is the above-described plastic substrate, if the display device 100A is bended, the cell thickness (thickness of light modulation layer 17) of the display device 100A can be maintained within a predetermined range, and leakage of the liquid does not occur even when cracking of the display device 100A occurs. In addition, a step to inject the electrolytic solution is not necessary, so that the number of members constituting the display device 100A can be decreased and the process to produce the display device 100A is simplified.

As for the solid electrolyte, for example, a polymer film containing Li (lithium) ions or the like or a plastic crystal is used.

The state in which the background is seen through (bleached state) and the colored state of the display device 100A can be switched by an applied voltage. Meanwhile, in the case where each of the first substrate 11 and the second substrate 21 is a glass substrate, the display device 100A may be attached to the windowpane with, for example, an adhesive having a refractive index nearly equal to that of the windowpane. In addition, in the case where the first substrate 11 and the second substrate 21 are pressure-resistant glass substrates which are used as windowpanes, the display device 100A can be used as a windowpane. Furthermore, in the case where each of the first substrate 11 and the second substrate 21 is a film substrate, attachment to a windowpane or the like is easy because of flexibility. In this regard, attachment to surfaces having various shapes becomes easy. For example, as shown in FIG. 10 (a), attachment to an electric apparatus (for example, an electric pot) 200 is possible. Meanwhile, as shown in FIG. 10 (b), attachment to the furniture (for example, living board) 300 enables display to take advantage of the pattern (for example, woodgrain) of the furniture 300.

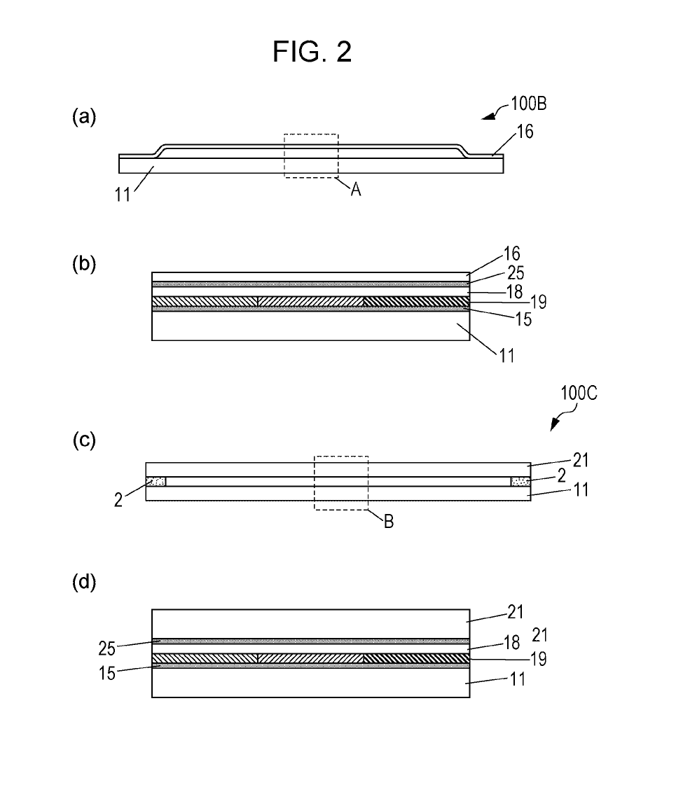

A display device 100B and a display device 100C in other embodiments according to the present invention will be described with reference to FIG. 2. In this regard, constituents common to the display device 100A are indicated by the same reference numerals as those set forth above and further explanations thereof will not be provided. FIG. 2 (a) is a diagram illustrating the configuration of the display device 100B, and FIG. 2 (b) is a magnified diagram of a portion surrounded by a broken line A in FIG. 2 (a). FIG. 2 (c) is a diagram illustrating the configuration of the display device 100C, and FIG. 2 (d) is a magnified diagram of a portion surrounded by a broken line B in FIG. 2 (c). The display device 100B and the display device 100C are see-through display devices by using a solid electrolyte. In this regard, a gel electrolyte or an electrically conductive polymer may be used in place of the solid electrolyte.

As shown in FIG. 2 (a) and FIG. 2 (b), the display device 100B includes a first substrate 11, a transparent electrode 15 disposed on the first substrate 11, an electrochromic layer 19 disposed on the side opposite to the first substrate 11 of the transparent electrode 15, a solid electrolyte layer 18 disposed on the side opposite to the first substrate 11 of the electrochromic layer 19, a transparent electrode 25 disposed on the side opposite to the first substrate 11 of the solid electrolyte layer 18, and a protective layer 16 disposed on the side opposite to the first substrate 11 of the transparent electrode 25. The protective layer 16 is disposed in such a way as to cover the electrochromic layer 19 and the solid electrolyte layer 18. It is more preferable that the protective layer 16 is disposed in such a way as to cover the side surface of the electrochromic layer 19 and the side surface of the solid electrolyte layer 18.

The transparent electrodes 15 and 25 are formed by a sputtering method or evaporation method of ITO or application of a solution containing ITO, for example. The transparent electrodes 15 and 25 can be formed from a film of, for example, PEDOT (polyethylene dioxythiophene) or polyaniline base, besides ITO.

The protective layer 16 is made from SiO₂ (silicon dioxide), for example. In addition, the protective layer 16 may have a stacking structure of an organic insulating layer/inorganic insulating layer.

As shown in FIG. 2 (c) and FIG. 2 (d), the display device 100C includes a first substrate 11 and a second substrate 21 disposed opposing to each other, a transparent electrode 15 disposed on the electrochromic layer 19 side of the first substrate 11, a transparent electrode 25 disposed on the electrochromic layer 19 side of the second substrate 21, an electrochromic layer 19 disposed on the side opposite to the first substrate 11 of the transparent electrode 15, and a solid electrolyte layer 18 disposed on the side opposite to the first substrate 11 of the electrochromic layer 19. The electrochromic layer 19 and the solid electrolyte layer 18 are disposed between the transparent electrode 15 and the transparent electrode 25. In addition, an adhesive resin, e.g., a sealant 2, is disposed around the first substrate 11 and the second substrate 21 so as to bond the first substrate 11 and the second substrate 21 together. For example, in the case where the first substrate 11 and the second substrate 21 in the display device 100C are plastic substrates, the display device 100C can be formed by a roll-to-sheet method.

In the display device 100B and the display device 100C, a voltage is applied to the electrochromic layer 19 by the solid electrolyte layer (gel electrolyte or electrically conductive polymer) 18. In the case where the solid electrolyte layer 18 is used, the pressure resistance of the display device 100B and the display device 100C is high. For example, the display device 100B and the display device 100C are not damaged easily even when being disposed on a floor, and leakage of liquid does not occur even if the display device is damaged.

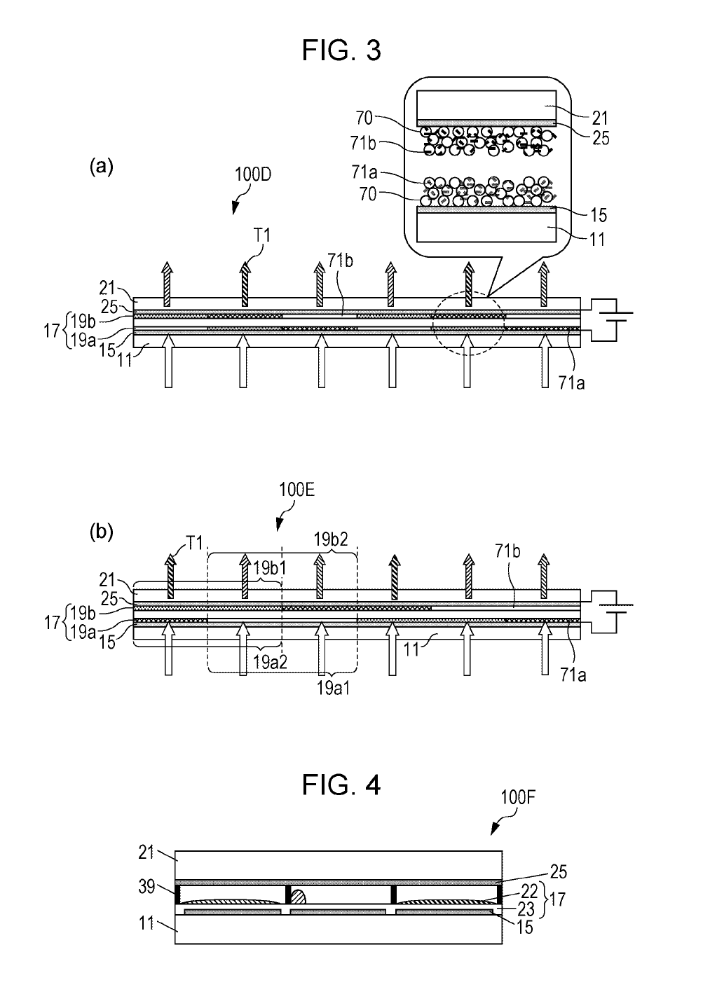

Next, a display device 100D and a display device 100E in other embodiments according to the present invention will be described with reference to FIG. 3. The display device 100D and the display device 100E are see-through display devices. FIG. 3 (a) and FIG. 3 (b) are schematic sectional views of display devices 100D and 100E, respectively.

As shown in FIG. 3 (a) and FIG. 3 (b), the display device 100D includes a first substrate 11, a transparent electrode 15 disposed on the first substrate 11, an oxidation type electrochromic layer 19a disposed on the transparent electrode 15, a second substrate 21 opposing to the first substrate 11, a transparent electrode 25 disposed on the second substrate 21, and the reduction type electrochromic layer 19b disposed on the transparent electrode 25. The light modulation layer 17 is formed from the oxidation type electrochromic layer 19a and the reduction type electrochromic layer 19b. In the case where the oxidation type electrochromic layer 19a and the reduction type electrochromic layer 19b are in the colored state, their light absorption wavelengths are different from each other. The oxidation type electrochromic layer 19a changes from the bleached state to the colored state by an oxidation reaction, and the reduction type electrochromic layer 19b changes from the bleached state to the colored state by a reduction reaction.

Examples of color production material 71a constituting the oxidation type electrochromic layer 19a include styryl based materials, and examples of color production material 71b constituting the reduction type electrochromic layer 19b include phthalic acid ester derivatives. Examples of methods for forming the individual layers include a method in which titanium oxide particles 70 are allowed to adsorb the individual materials. This forming method will be described.

As shown in FIG. 3 (a), the titanium oxide particles 70 are provided on the transparent electrodes 15 and 25 disposed on the first substrate 11 and the second substrate 21, respectively, and the titanium oxide particles 70 applied to one substrate are allowed to adsorb the oxidation type color production material 71a, so as to form the oxidation type electrochromic layer 19a. Meanwhile, the titanium oxide particles 70 applied to the other substrate are allowed to adsorb the reduction type color production material 71b, so as to form the reduction type electrochromic layer 19b. Thereafter, the first substrate 11 and the second substrate 21 are bonded together in such a way as to sandwich the electrochromic layers 19a and 19b therebetween.

The sizes of the titanium oxide particles 70 are preferably 1 nm or more and 100 nm or less, and more preferably 1 nm or more and 50 nm or less. In particular, in the case where the sizes of the titanium oxide particles 70 are 50 nm or less, Mie scattering of the visible light due to the titanium oxide particles 70 is suppressed and, thereby, the display device 100D exhibits high transparency. Meanwhile, the thickness of the layer formed from the titanium oxide particles 70 is preferably 1 μm or more and 10 μm or less. If the thickness of the layer formed from the titanium oxide particles 70 is more than 10 μm, the amount of adsorption of the color production material increases, although the transparency of the display device 100D is lost. In this regard, if the thickness of the layer formed from the titanium oxide particles 70 is less than 1 μm, the amount of adsorption of the color production material is small, and the color reproducibility of the display device 100D is poor. Meanwhile, the present inventors have performed various studies on the display device having an electrochromic layer (for example, PCT/JP2011/079049 (hereafter referred to as Patent application 1) and PCT/JP2011/078794 (hereafter referred to as Patent application 2)). The entire contents of Patent applications 1 and 2 are incorporated herein by reference.

The display device 100D in which the color production materials 71a and 71b different on a pixel basis are adsorbed to the titanium oxide particles 70 has been explained with reference to FIG. 3 (a). However, in a manner as that of the display device 100E shown in FIG. 3 (b), for example, in the case where the color production materials 71a and 71b different on two pixels adjoining in the line direction basis are adsorbed to the titanium oxide particles 70, the pitch of the regions which are allowed to adsorb the color production materials 71a and 71b can be increased, so that production becomes easy. Specifically, as shown in FIG. 3 (b), the oxidation type electrochromic layer 19a includes a first oxidation type electrochromic region 19a1 containing single oxidation type color production materials over two pixels adjoining in the line direction. Likewise, the reduction type electrochromic layer 19b includes a first reduction type electrochromic region 19b1 containing single reduction type color production materials over two pixels adjoining in the line direction. In addition, the oxidation type electrochromic layer 19a includes a second oxidation type electrochromic region 19a2 having two portions, which correspond to two pixels adjoining in the line direction and which contain oxidation type color production materials 71a having mutually different light absorption wavelengths in the colored state. Likewise, the reduction type electrochromic layer 19b includes a second reduction type electrochromic region 19b2 having two portions, which correspond to two pixels adjoining in the line direction and which contain reduction type color production materials 71b having mutually different light absorption wavelengths in the colored state. The light modulation layer 17 is disposed in such a way that the first oxidation type electrochromic region 19a1 and the second reduction type electrochromic region 19b2 are opposed to each other and the first reduction type electrochromic region 19b1 and the second oxidation type electrochromic region 19a2 are opposed to each other.

In the case where the light modulation layer 17 has the above-described two-layer structure, even when each of the color production materials 71a and 71b constituting the oxidation type electrochromic layer 19a and the reduction type electrochromic layer 19b, respectively, is a material having only one maximum absorption peak, the light T1 emitted from the display device 100D and the display device 100E can exhibit spectra of, for example, R (red) G (green), and B (blue).

Most of the above-described color production materials are materials having only one maximum absorption peak and, in particular, colors of cyan (C), magenta (M), and yellow (Y) are produced easily, although colors of R, G, and B are not produced easily. However, in the case where display with high color purity is performed by three colors, it is preferable that three colors of R, G, and B be used. In the present embodiment, the electrochromic layers 19a and 19b having two-layer structures are used and, therefore, R, G, and B can be displayed by using materials producing colors of C, M, and Y as their respective color production materials 71a and 71b, so that selectivity of the materials are high.

Meanwhile, there is a problem in that if, for example, ferrocene is used as a counter electrode agent (a material contained in a layer disposed opposing to, for example, the reduction type electrochromic layer 19b), the light modulation layer 17 is yellowed even when the light modulation layer 17 is in the bleached state. On the other hand, according to the present embodiment, the oxidation type electrochromic layer 19a and the reduction type electrochromic layer 19b exhibiting good color production property and bleaching property can be used and, therefore, predetermined color display can be obtained. In addition, oxidation (or reduction) of the counter electrode agent, which does not directly relate to color production, does not occur and both the oxidation type electrochromic layer 19a and the reduction type electrochromic layer 19b produce colors, so that the electric energy utilization efficiency is high.

Next, a see-through display device 100F in another embodiment according to the present invention will be described with reference to FIG. 4. FIG. 4 is a schematic sectional view of the display device 100F.

The display device 100F includes a first substrate 11, a transparent electrode 15 disposed on the first substrate 11, a water-repellent layer 23 disposed in such a way as to cover the transparent electrode 15, a second substrate 21 opposing to the first substrate 11, a transparent electrode 25 disposed on the second substrate 21, and a light modulation layer 17 disposed between the transparent electrode 15 and the transparent electrode 25. The transparent electrode 15 is disposed on a pixel basis, and the transparent electrode 25 is disposed evenly all over the display device. The light modulation layer 17 is an electrowetting layer. The light modulation layer 17 includes nonpolar solutions 22 having colors different on a pixel basis and a colorless (transparent) polar solution (not shown in the drawing), and walls 39 are disposed between the individual pixels. The nonpolar solutions 22 of the individual pixels are not mixed because of the walls 39. The water-repellent layer 23 is formed from, for example, a fluorine based resin and has water repellency. The nonpolar solutions 22 and the polar solvent (not shown in the drawing) are provided on the water-repellent layer 23. The display device 100F is an electrowetting display device.

As shown in FIG. 4, when a voltage is not applied, colored nonpolar solutions 22 cover the whole water-repellent layer 23 and the display device 100F comes into a colored state. On the other hand, as indicated by the center pixel shown in FIG. 4, when a voltage is applied, the colored nonpolar solution 22 moves to, for example, the wall 39 side of the pixel and the area covering the water-repellent layer 23 decreases, so that the display device 100F comes into a transparent (colorless) state. In this regard, a plurality of colored nonpolar solutions 22 can be provided to pixels separately on a color basis by using, for example, an ink jet method.

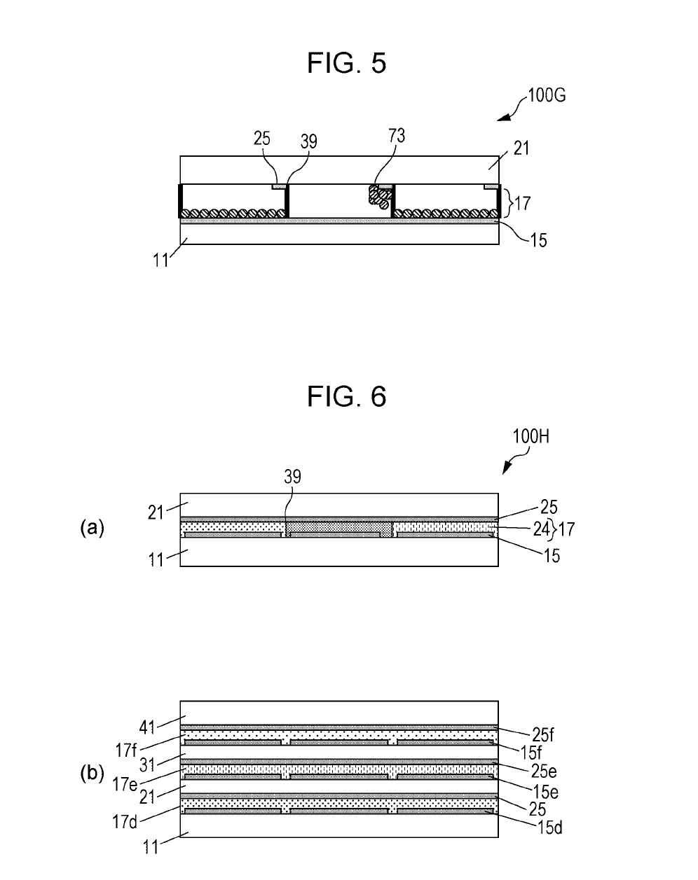

Next, a see-through display device 100G in another embodiment according to the present invention will be described with reference to FIG. 5. FIG. 5 is a schematic sectional view of the display device 100G.

The display device 100G includes a first substrate 11, a transparent electrode 15 disposed on the first substrate 11, a second substrate 21 opposing to the first substrate 11, a transparent electrode 25 disposed on the second substrate 21, and a light modulation layer 17 disposed between the transparent electrode 15 and the transparent electrode 25. The transparent electrode 25 is disposed on a pixel basis, and the transparent electrode 15 is disposed evenly all over the display device. Meanwhile, the size of the transparent electrode 25 is smaller than the size of the transparent electrode 15. In this regard, an electrode made from an opaque metal (for example, Al (aluminum)) may be used in place of the transparent electrode 25.

The light modulation layer 17 includes charged color fine particles 73 having colors different on a pixel basis and a solvent (for example, organic solvent) (not shown in the drawing), and walls 39 are disposed between the individual pixels. The charged color fine particles 73 contain, for example, pigment or dye. The organic solvent is a transparent organic solvent, e.g., toluene, xylene, paraffin, or silicone oil. When a voltage is applied to the light modulation layer 17, for example, the charged color fine particles 73 move between the transparent electrode 25 and the transparent electrode 15, so as to change the depth of a color of the display device 100G, and gray scale display can be performed. In this regard, in order to provide the plurality of colored charged color fine particles 73 to a predetermined region on a color basis, for example, a method in which the charged color fine particles 73 dispersed in a solution are provided in between the walls 39 partitioning on a pixel basis by the ink jet method is mentioned. Meanwhile, when the charged color fine particles 73 are not adjustable to a predetermined color, a plurality of charged color fine particles 73 having mutually different colors may be mixed in the same pixel. The display device 100G is a wet electrophoresis type display device. In this regard, the display device 100G can be modified to a dry electrophoresis type display device.

Next, a see-through display device 100H in another embodiment according to the present invention will be described with reference to FIG. 6. FIG. 6 (a) is a schematic sectional view of the display device 100H and FIG. 6 (b) is a schematic sectional view of a modified example of the display device 100H.

As shown in FIG. 6 (a), the display device 100H includes a first substrate 11, a transparent electrode 15 disposed on the first substrate 11, a second substrate 21 opposing to the first substrate 11, a transparent electrode 25 disposed on the second substrate 21, and a light modulation layer 17 disposed between the transparent electrode 15 and the transparent electrode 25. The transparent electrode 15 is disposed on a pixel basis, and the transparent electrode 25 is disposed evenly all over the display device 100H. In addition, a horizontal alignment film (not shown in the drawing) is disposed on each of the transparent electrodes 15 and 25. The horizontal alignment films have been subjected to an alignment treatment in such a way that their alignment treatment directions (for example, rubbing direction) become orthogonal to each other.

The light modulation layer 17 contains a nematic liquid crystal material (not shown in the drawing) of, for example, positive type (p-type) and dichromatic coloring agents 24 different on a pixel basis, and walls 39 formed from, for example, a black resin are disposed between the individual pixels. In addition, the nematic liquid crystal material contains a chiral agent and, for example, when a voltage is not applied, nematic liquid crystal molecules are twisted 270°. In the case where the nematic liquid crystal molecules are twisted 270° as described above, the absorption axis of the dichromatic coloring agent 24 is aligned in every direction. Therefore, the dichromatic coloring agent 24 absorbs every polarization of light and the light modulation layer 17 comes into a colored state. Meanwhile, when a voltage is applied to the light modulation layer 17, nematic liquid crystal molecules are aligned perpendicularly to the first substrate 11. The dichromatic coloring agent 24 is also aligned perpendicularly to the first substrate 11 depending on the alignment of nematic liquid crystal molecules. When the dichromatic coloring agent 24 is aligned perpendicularly to the first substrate 11, the light is not absorbed by the dichromatic coloring agent 24 sufficiently and the light modulation layer 17 comes into a bleached state. The display device 100H is produced by using, for example, the ink jet method. A thin display device 100H is obtained by providing the nematic liquid crystal material containing the dichromatic coloring agents 24 different on a pixel basis.

Also, as shown in FIG. 6 (b), the display device 100H can be modified to a display device in which light modulation layers 17d to 17f containing different dichromatic coloring agents are stacked. Such a display device can be produced by a simple method because it is not necessary to provide dichromatic coloring agents different on a pixel basis. In this regard, the light modulation layers 17d, 17e, and 17f are disposed between their corresponding transparent electrodes 15d and 25d, 15e and 25e, and 15f and 25f, respectively. The individual transparent electrodes 15d to 15f and 25d to 25f are disposed on their respective substrates 11, 21, 31, and 41.

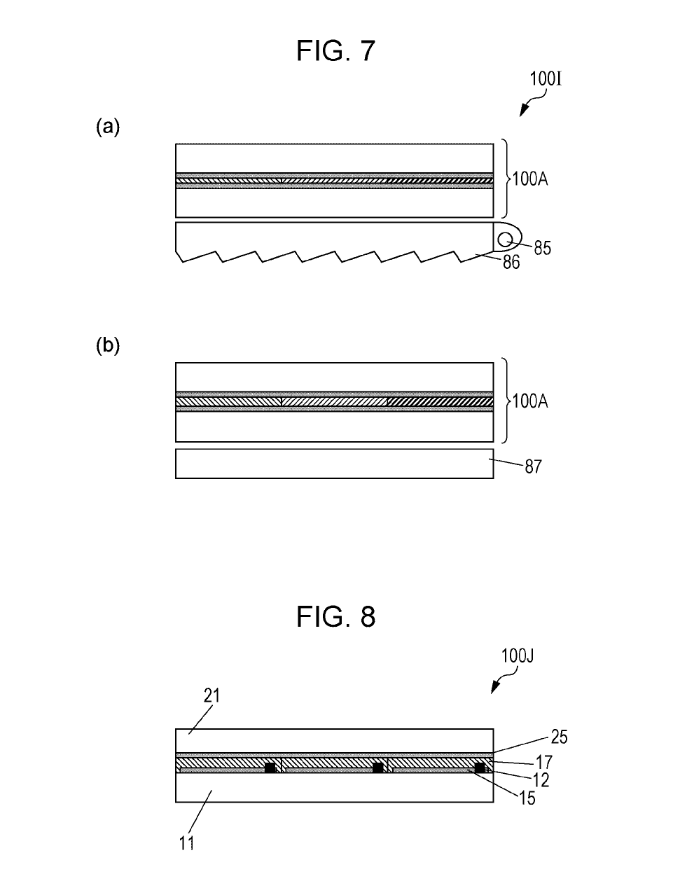

Next, a see-through display device 100I in another embodiment according to the present invention will be described with reference to FIG. 7. FIG. 7 (a) is a schematic sectional view of the display devices 100I and FIG. 7 (b) is a schematic sectional view of a modified example of the display device 100I.

The display device 100I shown in FIG. 7 (a) is, for example, a display device in which a light guide plate 86 equipped with a white LED (Light Emitting Diode) 85 on the side opposite to the light modulation layer 17 of the first substrate 11 in the display device 100A. Alternatively, the above-described display devices 100B to 100H or display devices 100J or 100K described later may be disposed in place of the display device 100A. Meanwhile, as shown in FIG. 7 (b), a transparent organic EL (Electro Luminescence) irradiation apparatus 87 may be disposed in place of the light guide plate 86 equipped with the white LED 85. The transparent organic EL irradiation apparatus 87 is, for example, an organic EL irradiation apparatus having a structure in which a transparent electrode is disposed on each of two transparent substrates and an organic EL layer containing an organic EL material is disposed between these transparent electrodes. Such an organic EL irradiation apparatus 87 is a known technology and, therefore, detailed explanation will not be provided. A display device, e.g., the display device 100I, having a structure in which a light-transmissive light-irradiation apparatus is disposed on the side opposite to the light modulation layer 17 side of the first substrate 11 can obtain high brightness even in a dark place.

Next, a see-through display device 100J in another embodiment according to the present invention will be described with reference to FIG. 8. FIG. 8 is a schematic sectional view of the display device 100J.

The display device 100J shown in FIG. 8 includes a first substrate 11 and a second substrate 21 disposed opposing to each other and a light modulation layer 17 disposed between the first substrate 11 and the second substrate 21. The light from the light modulation layer 17 has at least three absorption spectra different from each other depending on an applied voltage. One of the at least three absorption spectra has a light absorptivity of preferably 40% or less at the wavelength at which the light absorptivity is the lowest in a visible light region (the range of 400 nm or more and 800 nm or less), and the light absorptivity is more preferably 40% or less in the visible light region (the range of 400 nm or more and 800 nm or less). Here, the term “the absorption spectrum is different” includes that the absorption intensity is different. A plurality of transparent electrodes 15 are disposed on the first substrate 11. For example, a TFT 12 and a transparent electrode 15 are disposed on a pixel basis on the first substrate 11. Each transparent electrode 15 is electrically connected to the corresponding TFT 12. A transparent 25 is disposed on the second substrate 21 while being formed evenly all over the display device 100J. The light modulation layer 17 is disposed between the transparent electrode 15 and the transparent electrode 25.

The light modulation layer 17 in the display device 100J is an electrochromic layer. An electrochromic compound constituting the electrochromic layer is, for example, only one type. The electrochromic layer contains, for example, a viologen compound disclosed in Galt Bar, Solar Energy Materials and Solar Cells 93 (2009) 2118-2124 (refer to (Chem. 1)).

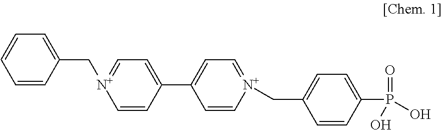 [SMILES: O=P(O)(O)c1ccc(C[n+]2ccc(-c3cc[n+](Cc4ccccc4)cc3)cc2)cc1]

In the case where a voltage is applied to the electrochromic layer made from the viologen compound, a bleached state (for example, a state in which the transmittance becomes 60% or more in the visible light region (the range of 400 nm or more and 800 nm or less)), a blue state, or a yellow state can be brought about depending on the magnitude of the voltage. For example, when 0 V of voltage is applied to the light modulation layer (electrochromic layer) 17, the light modulation layer 17 comes into a bleached state. When 1.5 V of voltage is applied to the light modulation layer 17, the light modulation layer 17 comes into a blue state, and when 2.5 V of voltage is applied to the light modulation layer 17, the light modulation layer 17 comes into a yellow state.

In a display device, e.g., the display device 100J, including the electrochromic layer, the depth of coloring of the electrochromic layer can be controlled in accordance with the magnitude of applied voltage or the voltage application time. Therefore, for example, the display device 100J can perform a plurality of gray scale display by controlling the magnitude of applied voltage on the basis of an active drive system.

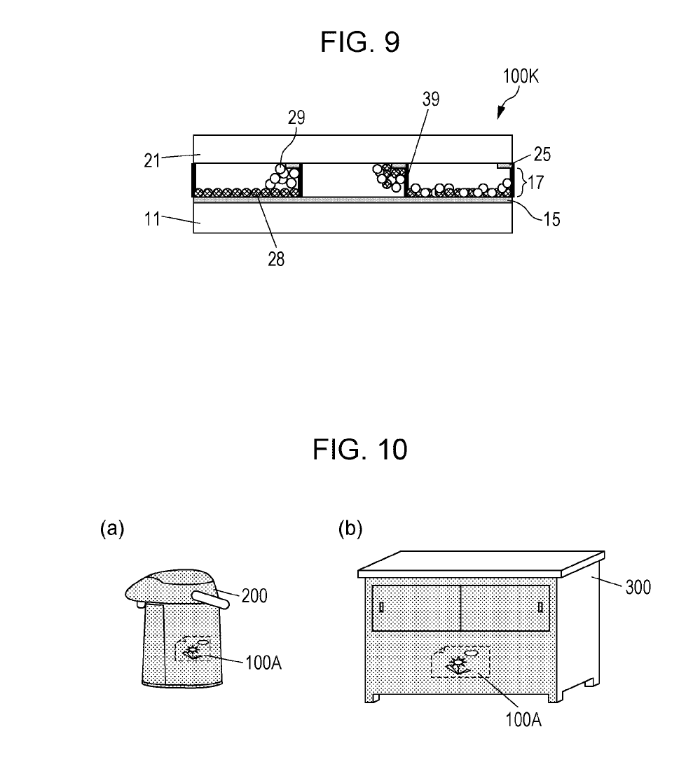

Next, a see-through display device 100K in another embodiment according to the present invention will be described with reference to FIG. 9.

The display device 100K shown in FIG. 9 includes a first substrate 11 and a second substrate 21 disposed opposing to each other and a light modulation layer 17 disposed between the first substrate 11 and the second substrate 21. The light from the light modulation layer 17 has at least three absorption spectra different from each other depending on an applied voltage. One of the at least three absorption spectra has a light absorptivity of preferably 40% or less at the wavelength at which the light absorptivity is the lowest in a visible light region (the range of 400 nm or more and 800 nm or less), and the light absorptivity is more preferably 40% or less in the visible light region (the range of 400 nm or more and 800 nm or less). A transparent electrodes 15 to apply a voltage to the light modulation layer 17 is disposed on a pixel basis on the first substrate 11. A transparent electrodes 25 to apply a voltage to the light modulation layer 17 is disposed on a pixel basis on the second substrate 21. The size of the transparent 15 is smaller than the size of the transparent electrode 25. Meanwhile, the transparent electrode 25 can be formed from an opaque electrode, e.g., Al.

The light modulation layer 17 in the display device 100K is an electrophoresis layer. Each pixel of the electrophoresis layer is provided with first charged color fine particles 28 having a first amount of charge and second charged color fine particles 29 having a second amount of charge smaller than the first amount of charge. In this regard, the electrophoresis layer includes a nonpolar solvent (for example, CₙH₂ₙ₊₂ (alkane)) (not shown in the drawing), and the first charged color fine particles 28 and the second charged color fine particles 29 are dispersed in the nonpolar organic solvent. The color of the first charged color fine particles 28 and the color of the second charged color fine particles 29 are different from each other. The first charged color fine particles 28 take on, for example, magenta and the second charged color fine particles 29 take on, for example, cyan. Meanwhile, both the first charged color fine particles 28 and the second charged color fine particles 29 are positively charged (for example, zeta potential is +20 mV to +100 mV). In this regard, the absolute value of each amount of charge may be adjusted appropriately in accordance with the purpose, e.g., the response speed or the magnitude of applied voltage. Also, walls 39 made from, for example, a photosensitive resin are disposed between pixels, so that adjacent pixels are separated from each other by the walls 39. In addition, for example, in the case where display is repeated, agglomeration of the first charged color fine particles 28 and the second charged color fine particles 29 into a part of region can be prevented by the walls. The thickness of the electrophoresis layer is, for example, 50 μm and is maintained by, for example, fiber spacers (not shown in the drawing). Also, a seal portion (not shown in the drawing) is disposed around the electrophoresis layer. The electrophoresis layer is hermetically held between the first substrate 11 and the second substrate 21 by the seal portion.

Next, a method for allowing the display device 100K to display will be described.

The potential applied to the transparent electrode 25 is specified to be Vat, and the potential applied to the transparent electrode 15 is specified to be Vbt. In the case where the relationship represented by Vat<Vbt is satisfied, the first charged color fine particles 28 and the second charged color fine particles 29 agglomerate in the vicinity of the transparent electrode 25, and the electrophoresis layer comes into a bleached state (refer to the center pixel shown in FIG. 9). At this time, it is preferable that Vat<0 V and 0 V<Vbt be satisfied. For example, Vat=−40 V and Vbt=+40 V. Here, 0 V is specified to be the potential of a ground or cabinet.

Then, the potential applied to the transparent electrode 25 is specified to be Vam, and the potential applied to the transparent electrode 15 is specified to be Vbm. In the case where the relationship represented by Vbm<Vam is satisfied, the first charged color fine particles 28 move in such a way as to cover the transparent electrode 15 (refer to the left pixel shown in FIG. 9), and the electrophoresis layer comes into a first colored (for example, magenta) state. For example, Vam=−10 V and Vbm=−20 V.

Then, the potential applied to the transparent electrode 25 is specified to be Van, and the potential applied to the transparent electrode 15 is specified to be Vbn. In the case where the relationship represented by Vbn<Vbm<Vam≦Van or Vbn≦Vbm<Vam<Van is satisfied, the first charged color fine particles 28 and the second charged color fine particles 29 move in such a way as to cover the transparent electrode 15 (refer to the right pixel shown in FIG. 9), and the electrophoresis layer comes into a second colored (for example, blue) state having a color different from the color of the first colored state. For example, Van=0 V and Vbn=−40 V. In this regard, it is preferable that all the above-described voltages Vam, Van, Vbm, and Vbn be 0 V or less.

As described above, display devices capable of multicolor and multi-gradation display are provided by the display devices 100A to 100K in the embodiments according to the present invention.

In all display devices 100A to 100K, in the case where a reflection prevention film, e.g., an AR (Anti-Reflection) film, a LR (Low-Reflection) film, or a moth-eye film, is disposed on at least one of the observer side of the display devices 100A to 100K and the side opposite to the observer side of the display devices 100A to 100K, display with enhanced transparent feeling can be performed. Meanwhile, the display devices 100A to 100K can be combined appropriately.

In the case where the display devices 100A to 100K according to the present invention are disposed on, for example, windows, mirrors, walls, refrigerators, desks, and floor surfaces, the display devices 100A to 100K can be switched to a transparent state, so that images, pieces of information, patterns, signs, guide of the inside of shops, and the like can be displayed without impairing images on the opposite side of a window as for the window and without impairing the original color of a desk or the like as for the desk or the like. Consequently, the display devices 100A to 100K can be disposed on places where it has been previously difficult to dispose display devices because functions and designs are impaired. In particular, in the case where a solid electrolyte is used, a see-through display device can be formed from the solid. Therefore, for example, in the case where the display device is disposed on a floor surface, even when a load is applied, the display device is not damaged easily. Even if the display device is damaged, a liquid, a powder, or the like is not scattered and the safety is high.

### INDUSTRIAL APPLICABILITY

The display device according to the present invention is favorably used for portable apparatuses and other various electronic apparatuses, e.g., cellular phones, pocket game machines, PDA (Personal Digital Assistants), portable TVs, remote controllers, notebook personal computers, and other portable terminals. Furthermore, the display device is also favorably used as large display devices, e.g., Information Displays and Digital Signages, and alternatives to windows.

### REFERENCE SIGNS LIST

11, 21, 31, 41 substrate
12 active element
15, 15a, 15b, 15c, 25, 25a, 25b, 25c transparent electrode
17, 17a, 17b, 17c light modulation layer
100A display device
200 electric apparatus
300 furniture

1. A see-through display device comprising:
a first substrate and a second substrate disposed opposing to each other; and
a light modulation layer disposed between the first substrate and the second substrate,
wherein the light modulation layer contains at least two types of materials which come into a bleached state or a colored state depending on an applied voltage and which have visible light absorption spectra different from each other.

2. The see-through display device according to claim 1, wherein the light modulation layer is an electrochromic layer.

3. The see-through display device according to claim 2, further comprising a solid electrolyte layer or an electrically conductive polymer layer,
wherein a voltage is applied to the electrochromic layer through the solid electrolyte layer or the electrically conductive polymer layer.

4. The see-through display device according to claim 3, further comprising a protective layer covering the solid electrolyte layer or the electrically conductive polymer layer and the electrochromic layer.

5. The see-through display device according to claim 4, further comprising a transparent electrode disposed on the electrochromic layer side of the protective layer.

6. The see-through display device according to claim 2,
wherein the electrochromic layer includes an oxidation type electrochromic layer and a reduction type electrochromic layer,
the oxidation type electrochromic layer has a first oxidation type electrochromic region containing a single oxidation type color production material over two pixels adjoining in a line direction, and
the reduction type electrochromic layer has a first reduction type electrochromic region containing a single reduction type color production material over two pixels adjoining in a line direction.

7. The see-through display device according to claim 6,
wherein the oxidation type electrochromic layer has a second oxidation type electrochromic region including two portions containing oxidation type color production materials, which correspond to two pixels adjoining in a line direction and which have light absorption wavelengths different from each other in a colored state,
the reduction type electrochromic layer has a second reduction type electrochromic region including two portions containing reduction type color production materials, which correspond to two pixels adjoining in a line direction and which have light absorption wavelengths different from each other in a colored state, and
the electrochromic layer is disposed in such a way that the first oxidation type electrochromic region is opposed to the second reduction type electrochromic region and the first reduction type electrochromic region is opposed to the second oxidation type electrochromic region.

8. The see-through display device according to claim 1, wherein the light modulation layer is an electrophoresis layer.

9. The see-through display device according to claim 8, comprising two electrodes to apply a voltage to the electrophoresis layer,
wherein the sizes of the two electrodes are different from each other.

10. The see-through display device according to claim 1, wherein the light modulation layer is a liquid crystal layer containing a dichromatic coloring agent.

11. The see-through display device according to claim 1, wherein the light modulation layer is an electrowetting layer.

12. The see-through display device according to claim 1, comprising a plurality of light modulation layers including the light modulation layer,
wherein the plurality of light modulation layers overlap each other when viewed from the direction normal to the first substrate.

13. A see-through display device comprising:
a first substrate and a second substrate disposed opposing to each other; and
a light modulation layer disposed between the first substrate and the second substrate,
wherein the light from the light modulation layer has at least three absorption spectra different from each other depending on an applied voltage, and
one of the at least three absorption spectra has a light absorptivity of 40% or less at the wavelength at which the light absorptivity is the lowest in a visible light region.

14. (canceled)

15. (canceled)

16. (canceled)

17. (canceled)

18. (canceled)

19. The see-through display device according to claim 13, wherein the light modulation layer is an electrophoresis layer.

20. The see-through display device according to claim 19,
wherein the electrophoresis layer contains first charged color fine particles having a first amount of charge and second charged color fine particles having a second amount of charge different from the first amount of charge, and
the color of the first charged color fine particles is different from the color of the second charged color fine particles.

21. The see-through display device according to claim 19, comprising a first electrode and a second electrode to apply a voltage to the electrophoresis layer,
wherein the size of the first electrode is smaller than the size of the second electrode.

22. The see-through display device according to claim 1, further comprising a light-transmissive light-irradiation apparatus disposed on the side opposite to the light modulation layer side of the first substrate.

23. The see-through display device according to claim 1, comprising a reflection type prevention film on at least one of the observer side of the see-through display device and the side opposite to the observer side of the see-through display device.

24. An electric apparatus comprising the see-through display device according to claim 1.

25. Furniture comprising the see-through display device according to claim 1.
